(19) United States
(12) Patent Application Publication
(10) Pub. No.: US 2006/0262534 A1
(43) Pub. Date: Nov. 23, 2006

(54) Decorative light display

(76) Inventor: John Hill, Coolidge, AZ (US)

Correspondence Address: WEISS & MOY PC, 4204 NORTH BROWN AVENUE, SCOTTSDALE, AZ, 85251, US

(21) Appl. No.: 11/132,515

(22) Filed: May 19, 2005

(51) Int. Cl. F21S 13/14

(52) U.S. Cl. 362/252

(57) ABSTRACT

A decorative light display that resembles the head of a game animal or a fictitious character and that is wall-mounted in taxidermic manner. Preferably, the decorative light display is equipped with an actuator that allows at least a portion of the head portion of the game animal or fictitious character to move.

### FIELD OF THE INVENTION

This invention relates generally to decorative light displays, and more specifically, to a decorative light display that resembles the head of a game animal or a fictitious character and that is wall-mounted in a taxidermic manner.

### BACKGROUND OF THE INVENTION

It is well-known that many people decorate their homes with light displays. During the holiday seasons, these light displays may take the shape of fictitious characters. Particularly during the Christmas season, these fictitious characters may be well-known Christmas characters, such as Frosty the Snowman, Santa Clause, and Rudolph the Red-nosed Reindeer. It is also well-known that many hunters have the heads of their kills stuffed and mounted on their walls. Many people, however, find taxidermy barbaric. Therefore, a need existed for a decorative light display that resembles the head of a game animal or a fictitious character and that is wall-mounted in taxidermic manner.

### SUMMARY OF THE INVENTION

An object of the present invention is to provide a decorative light display that resembles the head of a game animal and that is wall-mounted in taxidermic manner.

Another object of the present invention is to provide a decorative light display that resembles the head of a fictitious character and that is wall-mounted in taxidermic manner.

### BRIEF DESCRIPTION OF THE PREFERRED EMBODIMENTS

In accordance with one embodiment of the present invention, a decorative light display is disclosed. The decorative light display comprises a plaque having a front surface and a rear surface dimensioned to be coupled proximate a wall, a frame coupled to the front surface of the plaque, the frame being configured to resemble at least a head portion of an animal, a plurality of light emitters, and a plurality of electrical connectors, each connector having a first end dimensioned to be coupled to a portion of the frame and having a second end dimensioned to be coupled to and deliver electricity to at least one of the light emitters.

In accordance with another embodiment of the present invention, a decorative holiday theme light display is disclosed. The decorative holiday theme light display comprises a plaque having a front surface and a rear surface dimensioned to be coupled proximate a wall, a frame coupled to the front surface of the plaque, the frame being configured to resemble at least a head portion of a holiday character, a strand of light bulbs coupled in series, a plurality of electrical connectors, each connector having a first end dimensioned to be coupled to a portion of the frame and having a second end dimensioned to be coupled to and deliver electricity to at least one of the light bulbs of the strand, and an actuator coupled to at least one of the plaque and the frame and dimensioned to provide movement to at least a portion of the head portion of the holiday character.

In accordance with another embodiment of the present invention, a decorative light display is disclosed. The decorative light display comprises a plaque having a front surface and a rear surface dimensioned to be coupled proximate a wall, a frame coupled to the front surface of the plaque, the frame being configured to resemble at least a head portion of a game animal, a strand of light bulbs coupled in series, a plurality of electrical connectors, each connector having a first end dimensioned to be coupled to a portion of the frame and having a second end dimensioned to be coupled to and deliver electricity to at least one of the light bulbs of the strand; and an actuator coupled to at least one of the plaque and the frame and dimensioned to provide movement to at least a portion of the head portion of the game animal.

The foregoing and other objects, features, and advantages of the invention will be apparent from the following, more particular, description of the preferred embodiments of the invention, as illustrated in the accompanying drawings.

### BRIEF DESCRIPTION OF THE DRAWINGS

FIG. 1 is a perspective view of the decorative light display of the present invention. The light display is shown as resembling the head of the fictitious character of Rudolph the Red-nosed Reindeer.

FIG. 2 is a top view of the decorative light display of FIG. 1. The range of motion of the decorative light display is shown in phantom lines.

FIG. 3 is a perspective view of a light bulb coupled to the frame of the decorative light display of FIG. 1.

### DETAILED DESCRIPTION

The novel features believed characteristic of the invention are set forth in the appended claims. The invention will best be understood by reference to the following detailed description of illustrated embodiments when read in conjunction with the accompanying drawings, wherein like reference numerals and symbols represent like elements.

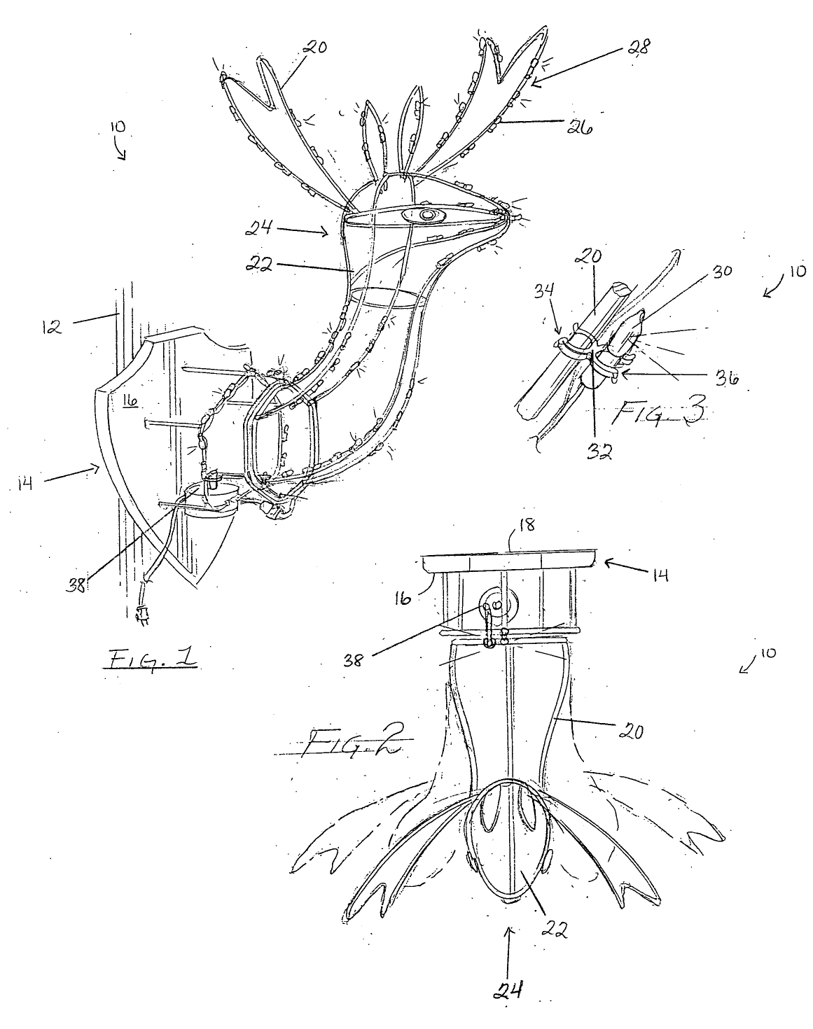

FIGS. 1-3 refer to the preferred embodiment of the present invention. Together, they show a decorative light display, hereinafter referred to as decorative light display 10, comprising a plaque 14 (see FIGS. 1-2), a frame 20, a plurality of light emitters 26 (see FIG. 1), and a plurality of electrical connectors 32 (see FIG. 3).

Referring to FIGS. 1 and 2, the plaque 14 has a front surface 16 and a rear surface 18 (see FIG. 2) dimensioned to be coupled proximate a wall 12 (see FIG. 1). The frame 20 is configured to resemble at least a head portion 22 of an animal 24 and is coupled to the front surface 16 of the plaque 14. Although the preferred embodiment shows the frame 20 as resembling only a head portion 22 of an animal 24, it should be clearly understood that substantial benefit may be derived from a frame 20 that resembles the entire body of the animal 24.

As shown, the animal 24 is the holiday character of Rudolph the Red-nosed Reindeer. Instead of being a fictitious character, the animal 24 may also be a game animal (not shown), such as a bird, a fish, a reptile, or a mammal. Although it is preferred that the animal 24 be either a game animal or a fictitious character, it should be clearly understood that substantial benefit may also be derived from the animal 24 being any type of animal, including a human, whether actual or fictitious. The decorative light display 10 further comprises a plurality of light emitters 26. Preferably, the light emitters 26 are a strand 28 (see FIG. 1) of light bulbs 30 (see FIG. 3), although it should be clearly understood that substantial benefit may be derived from individual light bulbs 30 or any other alternative light source.

Preferably, the decorative light display 10 further comprising an actuator 38 (see FIGS. 1-2) coupled to at least one of the plaque 14 and the frame 20. The actuator 38 is preferably dimensioned to provide movement to at least a portion of the frame 20 relative to the plaque 14. Specifically, the actuator 38 should allow at least a portion of the head portion 22 of the animal 24 to move (see FIG. 2).

Referring now to FIG. 3, the decorative light display 10 is shown as having a plurality of electrical connectors 32, each connector 32 having a first end 34 dimensioned to be coupled to a portion of the frame 20 and having a second end 36 dimensioned to be coupled to and deliver electricity to at least one of the light bulbs 30.

While the invention has been particularly shown and described with reference to preferred embodiments thereof, it will be understood by those skilled in the art that the foregoing and other changes in form and details may be made therein without departing from the spirit and scope of the invention. For example, although it is preferred that the decorative light display 10 have an actuator 38 to provide movement to at least a portion of the frame 20 relative to the plaque 14, it should be clearly understood that substantial benefit may derived from a decorative light display 10 that does not have an actuator 38.

I claim:

1. A decorative light display comprising:
a plaque having a front surface and a rear surface, said rear surface dimensioned to be coupled proximate a wall;
a frame coupled to said front surface of said plaque, said frame being configured to resemble at least a head portion of an animal;
a plurality of light emitters; and
a plurality of electrical connectors, each connector having a first end dimensioned to be coupled to a portion of said frame and having a second end dimensioned to be coupled to and deliver electricity to at least one of said light emitters.

2. The decorative light display of claim 1 wherein said animal being a game animal.

3. The decorative light display of claim 2 wherein said game animal being one of a bird, a fish, a reptile, and a mammal.

4. The decorative light display of claim 1 wherein said animal being a fictitious character.

5. The decorative light display of claim 4 wherein said fictitious character being Rudolph the Red-nosed Reindeer.

6. The decorative light display of claim 1 wherein said plurality of light emitters being a strand of light bulbs.

7. The decorative light display of claim 1 further comprising an actuator coupled to at least one of said plaque and said frame and dimensioned to provide movement to at least a portion of said frame relative to said plaque.

8. A decorative holiday theme light display comprising:
a plaque having a front surface and a rear surface, said rear surface dimensioned to be coupled proximate a wall;
a frame coupled to said front surface of said plaque, said frame being configured to resemble at least a head portion of a holiday character;
a strand of light bulbs coupled in series;
a plurality of electrical connectors, each connector having a first end dimensioned to be coupled to a portion of said frame and having a second end dimensioned to be coupled to and deliver electricity to at least one of said light bulbs of said strand; and
an actuator coupled to at least one of said plaque and said frame and dimensioned to provide movement to at least a portion of said head portion of said holiday character.

9. The decorative holiday theme light display of claim 8 wherein said holiday character being Rudolph the Red-nosed Reindeer.

10. A decorative light display comprising:
a plaque having a front surface and a rear surface, said rear surface dimensioned to be coupled proximate a wall;
a frame coupled to said front surface of said plaque, said frame being configured to resemble at least a head portion of a game animal;
a strand of light bulbs coupled in series;
a plurality of electrical connectors, each connector having a first end dimensioned to be coupled to a portion of said frame and having a second end dimensioned to be coupled to and deliver electricity to at least one of said light bulbs of said strand; and
an actuator coupled to at least one of said plaque and said frame and dimensioned to provide movement to at least a portion of said head portion of said game animal.

11. The decorative light display of claim 10 wherein said game animal being one of a bird, a fish, a reptile, and a mammal.
